(19) United States
(12) Patent Application Publication
(10) Pub. No.: US 2012/0122448 A1
(43) Pub. Date: May 17, 2012

(54) METHOD AND DEVICE FOR CONFIGURATION OF A MOBILE COMMUNICATION SYSTEM

(75) Inventors: Markus Dominik Mueck, Unterhaching (DE); Christian Drewes, Germering (DE); Andreas Schmidt, Braunschweig (DE)

(73) Assignee: INFINEON TECHNOLOGIES AG, Neubiberg (DE)

(21) Appl. No.: 12/945,931

(22) Filed: Nov. 15, 2010

(51) Int. Cl. H04W 24/02

(52) U.S. Cl. 455/424

(57) ABSTRACT

A method for configuration of a mobile communication system with a mobile communication network and a mobile terminal, which comprises determining a communication service quality required by a software application running on the mobile terminal for the transmission of data to be transmitted via a communication connection between the mobile communication network and the mobile terminal; and determining at least one of a base station of the mobile communication network to provide the communication connection and a radio frequency region to be used to provide the communication connection based on the required communication service quality.

### TECHNICAL FIELD

Embodiments generally relate to a method and a device for configuration of a mobile communication system.

### BACKGROUND

In modern mobile communication systems, communication connections may be provided using different types of base stations and/or radio cells (e.g. macro cells, fetmo cells, etc.) and frequency regions. Efficient methods, e.g. in terms of efficiency of resource usage, for selecting a base station, a radio cell and/or a frequency region etc. for providing a communication connection are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a communication system according to an embodiment.

FIG. 2 shows a communication system according to an embodiment.

FIG. 3 shows a flow diagram according to an embodiment.

FIG. 4 shows a device according to one embodiment.

FIG. 5 shows a radio cell arrangement according to an embodiment.

FIG. 6 shows a flow diagram according to an embodiment.

FIG. 7 illustrates frequency spectrum allocation according to an embodiment.

FIG. 8 illustrates frequency spectrum allocation according to an embodiment.

FIG. 9 shows a communication system according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

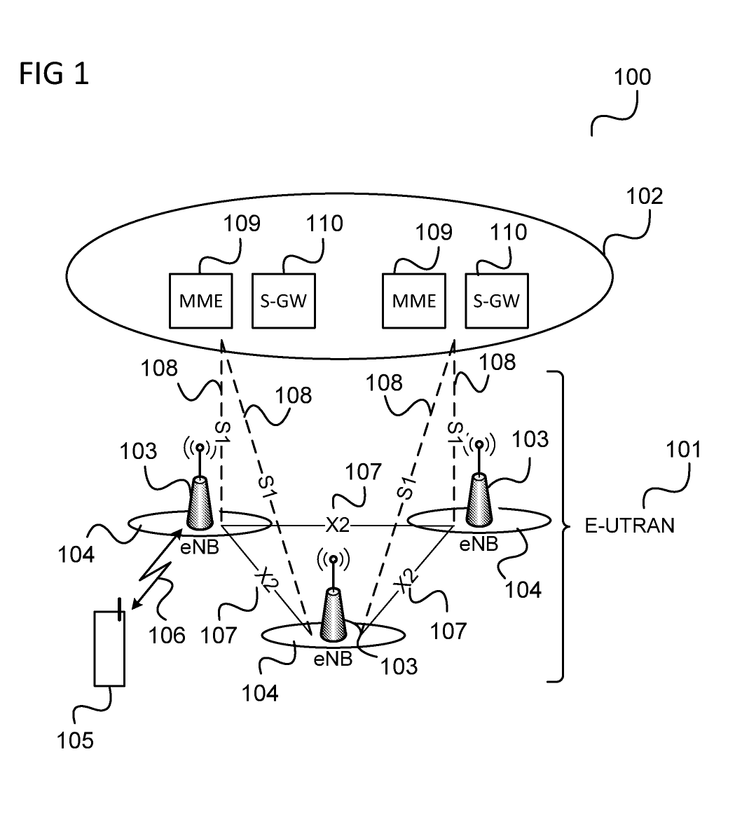

FIG. 1 shows a communication system 100 according to an embodiment.

According to this embodiment, the communication system 100 is configured in accordance with the network architecture of LTE. The communication system 100 may also be configured according to other communciation standards in other embodiments, e.g. according to UMTS (Univeral Mobile Telecommunications System).

The communication system 100 includes a radio access network (E-UTRAN, Evolved UMTS Terrestrial Radio Access Network) 101 and a core network (EPC, Evolved Packet Core) 102. The E-UTRAN 101 may include base (transceiver) stations (eNodeBs, eNBs) 103. Each base station 103 provides radio coverage for one or more mobile radio cells 104 of the E-UTRAN 101.

A mobile terminal (UE, user equipment) 105 located in a mobile radio cell 104 may communicate with the core network 102 and with other mobile terminals 105 via the base station providing coverage (in other words operating) in the mobile radio cell. A software application may be installed and run on the mobile terminal 105 for providing communication services for the user of the mobile terminal 105, e.g. speech communication, exchange of data, web browsing, etc. The software application is for example stored in a memory of the mobile terminal 105 and is carried out by a processor of the mobile terminal 105.

Control and user data are transmitted between a base station 103 and a mobile terminal located in the mobile radio cell 104 operated by the base station 103 over the air interface 106 on the basis of a multiple access method.

The base stations 103 are interconnected with each other by means of the X2 interface 107. The base stations are also connected by means of the S1 interface 108 to the core network (Evolved Packet Core) 102, more specifically to an MME (Mobility Management Entity) 109 and a Serving Gateway (S-GW) 110. The MME 109 is responsible for controlling the mobility of mobile terminals located in the coverage area of E-UTRAN, while the S-GW 110 is responsible for handling the transmission of user data between mobile terminals 105 and core network 102.

In one embodiment, according to LTE, the communication system 100 supports the following types of duplexing methods: full-duplex FDD (frequency division duplexing), half-duplex FDD and TDD (time division duplexing). According to full-duplex FDD two separate frequency bands are used for uplink transmission (i.e. transmission from mobile terminal 105 to base station 103) and downlink transmission (i.e. transmission from base station 103 to mobile terminal 105) and both transmissions can occur simultaneously. According to half-duplex FDD also two separate frequency bands are used for uplink and downlink transmissions, but both transmissions are non-overlapping in time. According to TDD the same frequency band is used for transmission in both uplink and downlink. Within a time frame the direction of transmission may be switched alternatively between downlink and uplink.

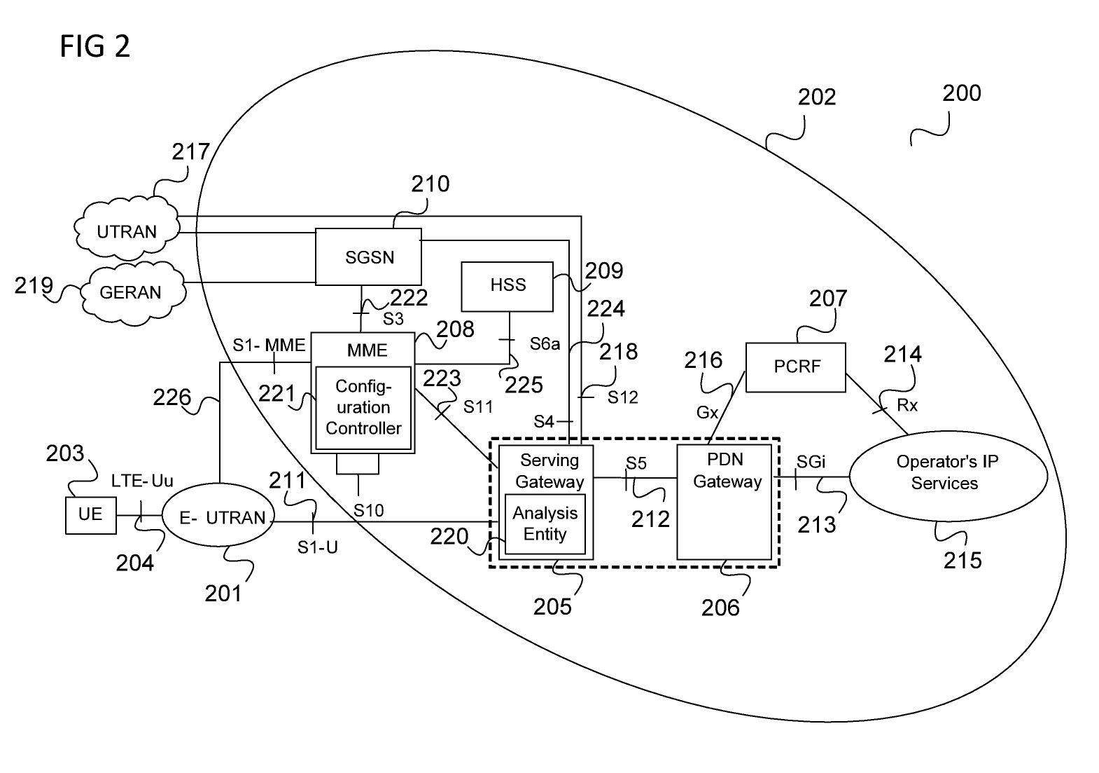

Another view of a communication system according to an embodiment is given in FIG. 2.

FIG. 2 shows a communication system 200 according to an embodiment.

The communication system 200 includes an E-UTRAN 201 and a core network 202.

The communication system 200 corresponds to the communication system 100 wherein in FIG. 1, the E-UTRAN 101, 201 is shown in higher detail while in FIG. 2, the core network 102, 202 is shown in higher detail.

A mobile terminal 203 which may correspond to the mobile terminal 105 may connect to the E-UTRAN 201 by means of an air interface (Uu interface) 204.

The core network 202 includes a Serving Gateway 205, a PDN (Packet Data Network) Gateway 206, a PCRF (Policy and Charging Rules Function) 207, an MME (Mobility Management Entity) 208, and a HSS (Home Subscriber Server) 209, an SGSN (Serving GPRS (General Packet Radio Service) Support Node) 210.

The E-UTRAN 201 exchanges information or commands with the Serving Gateway 205 by means of an S1-U interface 211. The Serving Gateway 205 is coupled to the PDN Gateway 206 by means of an S5 interface 212. The PDN Gateway 206 and the PCRF 207 may access IP (Internet Protocol) services 215 (i.e. may access, for example, corresponding servers) provided by the operator of the mobile communication system 200 by means of an SGi interface 213 and an Rx interface 214, respectively.

The PCRF 207 is coupled to the PDN Gateway 206 by means of a Gx interface 216. The Serving Gateway 205 is coupled by means of an S4 interface 224 with the SGSN 210. The Serving Gateway 205 may further be coupled to an UTRAN (i.e. a radio access network according to UMTS) 217 via a S12 interface 218. The MME 208 is coupled by means of an S6a interface 225 with the HSS 209. The MME 208 is further coupled by means of an S1-MME interface 226 to the E-UTRAN 201.

The SGSN 210 may support legacy access to the UTRAN 217 and/or a GERAN (GSM (Global System for Mobile Communications) EDGE (Enhanced Data Rates for GSM Evolution) Radio Access Network) 219. The SGSN 210 is coupled with the MME 208 via an S3 interface 222. The Serving Gateway 205 is coupled with the MME 208 via an S11 interface 223.

According one embodiment, illustratively, a communication service quality requirement is determined and a communication network configuration is set according to the communication service quality requirement.

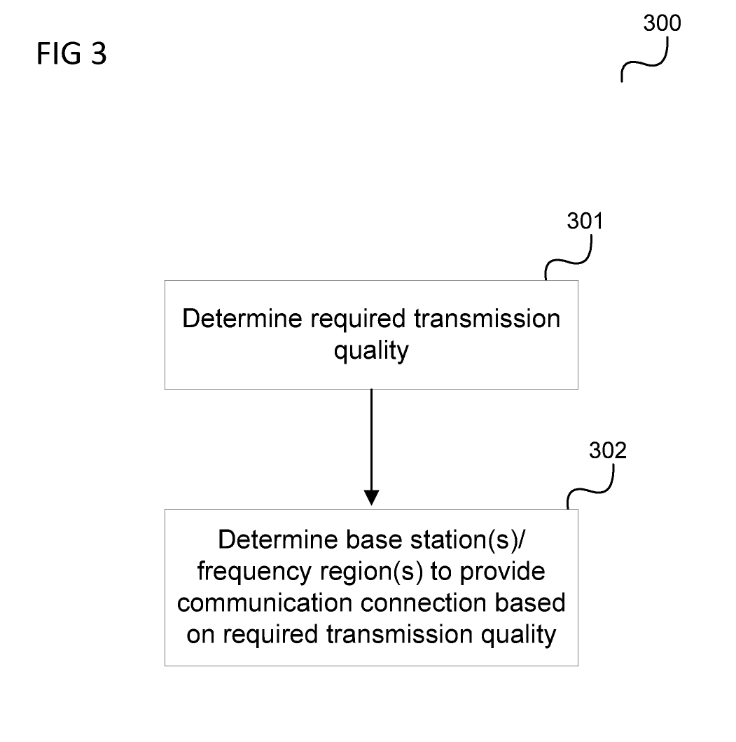

For example, according to one embodiment, the method illustrated in FIG. 3 is carried out.

FIG. 3 shows a flow diagram 300 according to an embodiment.

The flow diagram 300 illustrates a method for configuration of a mobile communication system including a mobile communication network and a mobile terminal.

In 301, a communication service quality required by a software application running on the mobile terminal for the transmission of data to be transmitted via a communication connection between the mobile communication network and the mobile terminal is determined.

In 302, at least one of a base station of the mobile communication network to provide the communication connection and a radio frequency region to be used to provide the communication connection is determined based on the required communication service quality.

The frequency region may include at least one (contiguous) frequency region part and may for example be a frequency region including a plurality of (separate contiguous) frequency region parts which are distributed over the spectrum; in other words, the frequency region does not need to be one contiguous frequency region but may comprise a plurality of frequency region parts. Furthermore, the method may include determining a plurality of frequency regions.

Illustratively, according to one embodiment, a network configuration is determined (and, according to one embodiment, applied) for a mobile terminal, e.g. a configuration of a communication connection to be provided for the mobile terminal, based on transmission requirements of an application running on the mobile terminal According to one embodiment, a suitable assignment of frequency region(s) and/or base station assignment for the mobile terminal is determined. For example, the overall spectrum configuration of the mobile communciation system (e.g. the frequency bands available) are taken into account for selecting appropriate resources for providing a communication connection (and/or a communication service) for the mobile terminal.

The determination of a base station and a frequency region may include a selection of a base station and/or a frequency region in at least one of or a combination of the scenarios of a system deployment with overlapping radio cells of different types, multi-band availability in a communication system, availability of contiguous/non-contiguous spectrum, the possibility of White Space usage (cognitive radio) by the mobile terminal as “secondary system” and the possibility of heterogenous system usage by a mobile terminal. The determination of a base station and/or a frequency region may for example include selection of
a cell type and/or
a radio band and/or
an aggregated/non-aggregated spectrum (in other words non-contiguous/contiguous spectrum) and/or
frequency regions that may be used for opportunistic spectrum access (such as white spaces) and/or
a radio access system

depending on, e.g.,
Quality of Service (QoS) requirement functions and/or
user cost functions and/or
network cost functions and/or
user velocity and/or
user location and/or
user contract.

The selection criteria may for example be grouped into classes, e.g.,
application classes
mobility classes
user classes.

The selection (determination) can for example be done
autonomously by the mobile terminal or controlled by the mobile communication network;
during idle mode of the mobile terminal, e.g. cell selection and cell reselection including cell change orders;
during call establishment, e.g. cell reselection followed by call setup or call setup followed by a handover;
during an ongoing communication connection (e.g. a call), e.g. in case the environment changes (e.g. due to mobility) or in case the transmission requirements change (e.g. in case multiple applications/radio bearers are active), for example resulting in a handover.

In addition to the communication service quality, the determination of the base station and/or the frequency region may also be based on other information, e.g. based on at least one of a type of subscription of the user of the mobile terminal, required power consumption of the mobile terminal for using the base station and/or the frequency region, and required output power of the mobile terminal and/or the base station for using the base station and/or the frequency region.

According to one embodiment, at least one of the base station and the radio frequency region is determined based on a predetermined selection criterion.

According to one embodiment, the mobile communication network is a wide area network (WAN). Wide area network may be understood to include wide area mobile networks and may for example be understood to include a PLMN (public land mobile network), i.e. a communication network established and operated by a mobile network operator for the purpose of providing land mobile telecommunications services to the public.

According to one embodiment, the base station is a base station of a plurality of base stations operating radio cells of a wide area network cell type.

The communication service quality is for example a Quality of Service required by the software application. The communication service quality required by the software application may for example include a required transmission quality of the software application, e.g. a maximum error rate, a maximum latency, a minimum data rate etc. The required communication service quality may for example also be a maximum number of handovers of the mobile terminal.

The determination of a base station of the mobile communication network may for example include the selection of a base station of a plurality of base stations.

In one embodiment, at least two base stations of the plurality of base stations are base stations according to different radio access technologies.

In one embodiment, at least one base station of the plurality of base stations is a macro base station and at least one base station of the plurality of base station is a low power node.

The low power node for example operates a micro cell, a femto cell or a pico cell.

In one embodiment, the determination of a base station of the mobile communication network includes the selection of a plurality of base stations to provide the communication connection.

The determination of a radio frequency region to be used to provide the communication connection may for example includes selecting a frequency region from a plurality of frequency regions. The frequency region may for example be a frequency band of a plurality of frequency bands that each include a plurality of frequency channels of a distinct radio access technology. For example, the frequency region may be an LTE band of a plurality of available LTE bands. A frequency region may also refer to a frequency band of a plurality of frequency bands assigned to different radio access technologies. For example, the frequency region may refer to a frequency region available for opportunistic spectrum access, e.g. a white space frequency region.

For example, at least one frequency region of the plurality of frequency regions is contiguous and at least one frequency region of the plurality of frequency regions is non-contiguous.

For example, the plurality of frequency regions includes a first frequency region and a second frequency region and the frequencies of the first frequency region are higher than the frequencies of the second frequency region.

In one embodiment, the plurality of frequency regions includes at least one frequency region assigned to another mobile communication system.

The plurality of frequency regions may for example include at least one White Space frequency region or generally a frequency region open for opportunistic spectrum access.

In one embodiment, the plurality of frequency regions includes at least one dedicated frequency region of the mobile communication system.

In one embodiment, the determining of the communication service quality required by the software application includes analyzing the type(s) of data transmitted between the mobile communication network and the mobile terminal.

According to one embodiment, the determining of the communication service quality required by the software application including determining a communication service used by the software application.

The determining of the communication service quality required by the software application may for example include receiving, by the mobile communication network, an indication of the communication service quality from the mobile terminal.

The method may further include providing a communication connection for the mobile terminal according to the determination of a base station and/or a radio frequency region.

The method illustrated in FIG. 3 is for example at least partially carried out by a component of the mobile communication network and/or at least partially carried out by the mobile terminal, e.g. a component of the mobile terminal.

According to one embodiment, the method further comprises checking whether another base station other than the determined base station is available for providing another communication connection between the mobile communication network and the mobile terminal ensuring the communication service quality; and providing the other communication connection for the transmission of the data using the other base station if the other base station is available for providing the other communication connection and if a predetermined criterion is fulfilled.

The predetermined criterion is for example that the other communication connection ensures a higher communication service quality than the communication connection or that the determined base station will no longer be available for providing the communication connection.

According to one embodiment, the method further comprises checking whether another radio frequency region other than the determined radio frequency region is available for providing another communication connection between the mobile communication network and the mobile terminal allowing a higher communication service quality than the determined radio frequency region; and providing the other communication connection for the transmission of the data using the other frequency region if the other frequency region is available for providing the other communication connection and if a predetermined criterion is fulfilled.

The predetermined criterion is for example that the other communication connection ensures a higher communication service quality than the communication connection or that the determined base station will no longer be available for providing the communication connection.

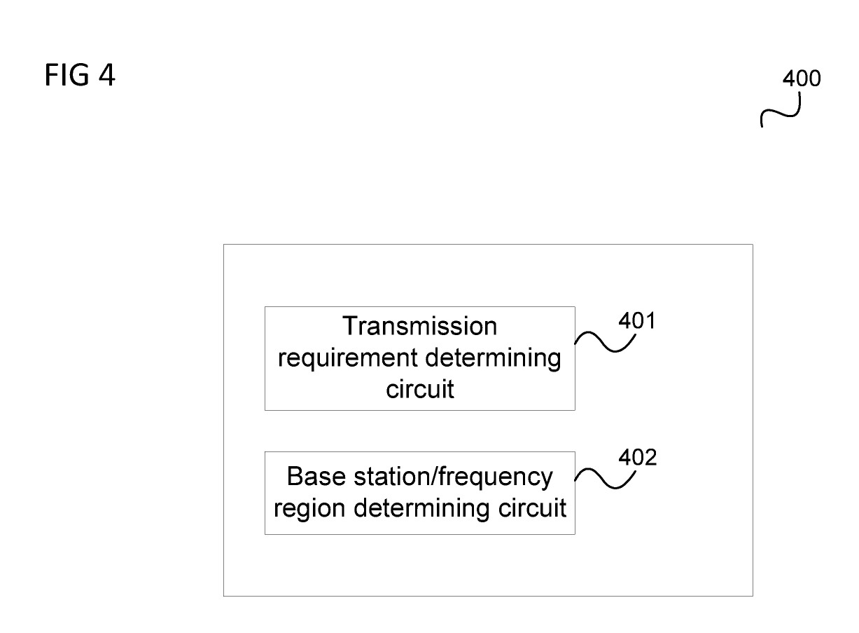

The method is for example carried out by a device (e.g. a mobile terminal component) as illustrated in FIG. 4.

FIG. 4 shows a device (e.g. mobile terminal component) 400 for configuration of a mobile communication system including a mobile communication network and a mobile terminal according to one embodiment.

The device 400 includes a first determining circuit 401 configured to determine a communication service quality required by a software application running on the mobile terminal for the transmission of data to be transmitted via a communication connection between the mobile communication network and the mobile terminal.

The device 400 further includes a second determining circuit configured to determine at least one of a base station of the mobile communication network to provide the communication connection and a radio frequency region to be used to provide the communication connection based on the required communication service quality.

It should be noted that embodiments described in context with the method for configuration of a mobile communication system are analogously valid for the device for configuration of a mobile communication system and vice versa.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Examples for network configurations or network parameters that may be set according to the communication service quality requirement are given in the following.

For example, a communication system (such as the communication system 100 shown in FIG. 1) may use multiple frequency bands and/or spectrum aggregation techniques which split the bandwidth per user over multiple junks of spectrum. Further, cognitive radio related applications (e.g. based on so-called White Spaces) may lead to distinct levels of the provided Quality of Service for different frequency bands.

According to one embodiment, the frequency bands to be used for a communication service and/or the base station to provide a communication service is/are set based on a required Quality of Service of a communication service. In other words, a mapping from a service (e.g. according to the Quality of Service required by the service) to one or more frequency bands or a base station (or a certain type of a base station) is used according to one embodiment.

In the following, scenarios are described in which a network configuration may be set based on a required or desired Quality of Service.

System Deployment with Overlapping Radio Cells of Different Types

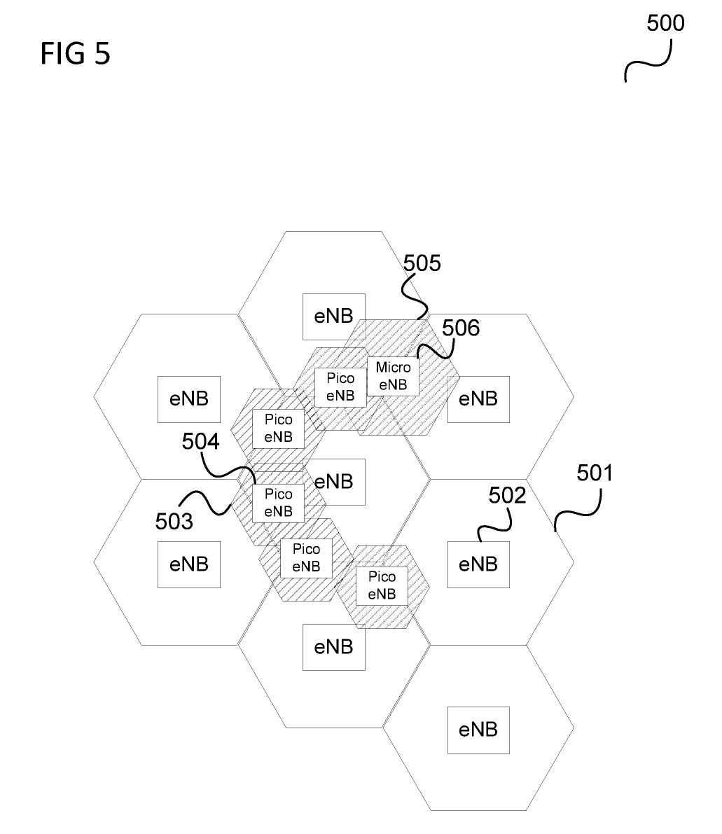

According to one embodiment, a mobile communication system is used which includes radio cells of different types (e.g. macro cells, micro cells, pico cells, femto cells etc.) with overlapping coverage areas. This is illustrated in FIG. 5.

FIG. 5 shows a radio cell arrangement 500 according to an embodiment.

The radio cell arrangement 500 includes a plurality of macro cells 501 operated by a plurality of base stations 502, for example corresponding to base stations 103 of the communication system illustrated in FIG. 1.

The radio cell arrangement further includes a plurality of radio cells operated by low power nodes, in this example a plurality of pico cells 503 operated by a plurality of pico base stations 504 and a micro cell 505 operated by a micro base station 506. The coverage area of the macro cells 501 overlaps with the coverage area of the pico cells 503 and the micro cell 505.

According to 3GPP, when camped on a cell, a mobile terminal may regularly search for a better radio cell according to cell reselection criteria. If a better cell is found, that cell is selected. The change of cell may imply a change of the radio access technology used.

Examples for parameters based on which a cell reselection may be carried out are given in table 1 (for UTRAN) and table 2 (for E-UTRAN).

TABLE 1
Cell (Re-)Selection Criteria for UTRAN

| | |
|---|---|
| Squal | Cell Selection quality value (dB) |
| | Applicable only for FDD cells. |
| Srxlev | Cell Selection RX level value (dB) |
| Q_{qualmeas} | Measured cell quality value. The quality of the received signal expressed |
| | in CPICH E_{c}/N₀ (dB) for FDD cells. CPICH Ec/N0 shall be averaged. |
| | Applicable only for FDD cells. |
| Qᵣₓₗₑᵥₘₑₐₛ | Measured cell RX level value. This is received signal, CPICH RSCP for |
| | FDD cells (dBm) and P-CCPCH RSCP for TDD cells (dBm). |
| Qqualmin | Minimum required quality level in the cell (dB). Applicable only for FDD |
| | cells. |
| QqualminOffset | Offset to the signalled Qqualmin taken into account in the Squal |
| | evaluation as a result of a periodic search for a higher priority PLMN |
| | while camped normally in a VPLMN [5] |
| Qrxlevmin | Minimum required RX level in the cell (dBm) |
| QrxlevminOffset | Offset to the signalled Qrxlevmin taken into account in the Srxlev |
| | evaluation as a result of a periodic search for a higher priority PLMN |
| | while camped normally in a VPLMN [5] |
| Pcompensation | max(UE_TXPWR_MAX_RACH − P_MAX, 0) (dB) |
| UE_TXPWR_MAX_RACH | Maximum TX power level an UE may use when accessing the cell on |
| | RACH (read in system information) (dBm) |
| P_MAX | Maximum RF output power of the UE (dBm) |

TABLE 2
Cell (Re-)Selection Criteria for E-UTRAN

| | |
|---|---|
| Srxlev | Cell Selection RX level value (dB) |
| Qᵣₓₗₑᵥₘₑₐₛ | Measured cell RX level value (RSRP). |
| Qᵣₓₗₑᵥₘᵢₙ | Minimum required RX level in the cell (dBm) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN [5] |
| Pcompensation | max(P_{EMAX}_{_{—}}_{H} − P_{PowerClass}, 0) (dB) |
| P_{EMAX}_H | Maximum TX power level an UE may use when |
| | transmitting on the uplink in the cell (dBm) defined as |
| | P_{EMAX}_{_{—}}_{H} in [TS 36.101] |
| P_{PowerClass} | Maximum RF output power of the UE (dBm) according |
| | to the UE power class as defined in [TS 36.101] |

The selection criteria or selection parameters according to tables 1 and 2 may be seen to be mainly based on radio parameters.

According to one embodiment, service classes and/or mobile terminal software applications to be run are taken into account for cell selection and/or cell reselection.

According to one embodiment, the selection criteria or selection parameters according to tables 1 and 2 are used and are dynamically reconfigured according to Quality of Service requirements, for example of an application running on a mobile terminal.

According to one embodiment, a Quality of Service-based handover (e.g. from a macro cell 501 to a pico cell 503, or a micro cell 505, a femto cell etc.) may be carried out. For example, it can be checked whether one or more certain criteria are fulfilled for, for example, a U-Plane (user plane) data transmission change (e.g. a switch from a streaming of data to burst data transmission, etc.). For example, transmitted data packets are checked (e.g. the headers are analysed) in order to detect a type of data traffic, e.g. HTTP (Hypertext Transfer Protocol) data traffic. According to one embodiment, a mobile terminal is associated with a base station of a certain type (e.g. a macro base station 503, a pico base station 504, etc.), i.e. a base station of a certain type is selected to provide a communication connection based on an application running on the mobile terminal, e.g. based on a type of data traffic (e.g. streaming, burst transmission) carried out by the application.

According to one embodiment, in a scenario where a mobile terminal is in the coverage area of a macro cell 501 and a low power node cell, e.g. a pico cell 503 or a femto cell at the same time, and has a communication connection via the macro cell 501, when the user of the mobile terminal starts to download high amounts of data using his mobile terminal, the type of communication service (e.g. data download) may be detected in the mobile communication network and the communication connection may be handed over to the low power node cell (assuming that there is no CSG (Closed Subscriber Group) restriction forbidding this). Thus, according to one embodiment, the macro cell may be freed from the voluminous resource request of the data download (e.g. achieving load balancing) and better link quality may be achieved since the radio link between a mobile terminal and a femto cell base station, for example, may typically have a better channel quality than a communication connection between the mobile terminal and a macro cell base station.

For example, it is assumed that radio cells of distinct types are available and base stations are serving radio cells of various cell sizes, including Macro-Cell base stations, Micro-Cell base stations, Nano-Cell base stations, Pico-Cell base stations and/or Femto-Cell base stations (which may in this order correspond to an ordering from largest possible cell radius to smallest cell radius). A base station serving a radio cell with a smaller cell radius may be expected to provide higher data rate services to users than a base station serving a radio cell with a larger cell radius, for example due to the physical proximity of the users to the base stations or the lower number of users in the cell.

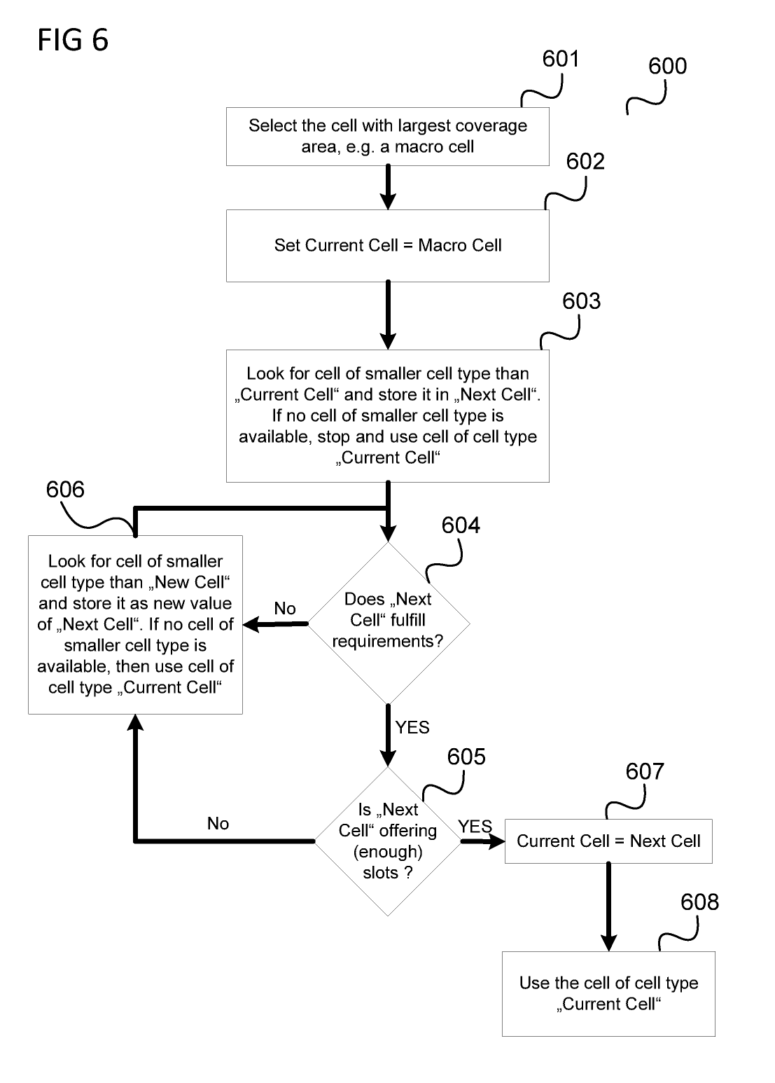

An initial cell-selection procedure for a mobile terminal according to one embodiment in a scenario where the coverage area of radio cells of different sizes overlap is described in the following with reference to FIG. 6.

FIG. 6 shows a flow diagram 600 according to an embodiment.

In 601, the cell selection is initiated by selecting a radio cell with the largest cell radius (i.e. the largest coverage area), for example a macro cell, for the mobile terminal.

It is assumed that the control entity (e.g. the base station) of the initially selected largest cell has knowledge about the smaller cells contained within (or having at least overlapping coverage area with) the initially selected largest cell, e.g. as mentioned above micro cells, nano cells, etc.

In 602, the control entity of the selected largest cell checks whether the mobile terminal can be handed off to a smaller cell. This process is in this example started by setting

### Current Cell=Macro Cell

for the case that the selected largest cell is a macro cell. If the selected largest cell is not a macro cell, the variable “Current Cell” is set to the corresponding cell type of the selected largest cell.

In 603, the next smaller cell type than the one given by the variable “Current Cell” for which a radio cell is available is determined. This cell type is stored in the variable “Next Cell”. If no radio cell of a smaller cell type than the one given by the variable “Current Cell” is available the radio cell having the cell type given by the variable “Current Cell” is used and the cell search (i.e. the cell selection process) is stopped.

In 604, it is determined whether the cell type stored in the variable “Next Cell” is fulfilling the communication service quality requirements (e.g. QoS requirements) of the mobile terminal. If it fulfills the communication service quality requirements, the process continues with 605, otherwise, the process continues with 606.

In 605, it is checked whether the cell of the cell type given by “Next Cell” has a free slot for the mobile terminal, e.g. whether radio resources are available in the cell to be allocated to the mobile terminal or whether the base station is able to serve the mobile terminal (e.g. in addition to other mobile terminals).

If a free slot is available, the process continues with 607. Otherwise, it continues with 606.

In 606, the next smaller cell type than the one given by the variable “New Cell” for which a radio cell is available is determined. This determined cell type is assigned as the new value for the variable “Next Cell”. If no radio cell of a smaller cell type than the one given by the variable “New Cell” is available the radio cell having the cell type given by the variable “Current Cell” is used and the cell search (i.e. the cell selection process) is stopped.

In 607, the variable “Current Cell” is set to the cell type given by the variable “Next Cell”. The process then continues with 608.

In 608, the radio cell of the cell type given by “Current Cell” is assigned to the mobile terminal and the search is stopped.

In one embodiment, the initial cell-selection procedure includes that the mobile terminal connects to a cell of any cell type (Macro-Cell, Micro-Cell, etc.). In this case, for example, a hand-off selection procedure is initiated according to the following:
1. Automatic Handover if link to the selected cell is unable to fully satisfy the communication service quality requirements (e.g. QoS requirements) and a cell becomes available providing a higher communication service quality.
2. Automatic Handover if the mobile terminal currently uses a radio cell providing a higher communication service quality (e.g. QoS) than actually needed by the mobile terminal. The mobile terminal is then for example directed to a radio cell providing lower communication service quality, making the current slot available for a mobile terminal requiring higher communication service quality.
3. Handover to a smaller cell (or in general to cells allowing a higher communication service quality) if currently selected cell type does not provide sufficient communication service quality for current requirements (e.g. current “Application Class”) of the mobile terminal
4. Handover to a larger cell (or in general to cells allowing only a lower communication service quality) if currently selected cell type does not provide sufficient communication service quality for current mobility level (e.g. a according to the “Mobility Class”) of the mobile terminal (i.e. if too many handovers occur).

The cell selection/re-selection as described above, e.g. the flow described with reference to FIG. 6 may for example be included into the cell selection/reselection process (e.g. the cell reselection evaluation process) according to 3GPP. In other words, according to one embodiment, the functions/processes of the mobile communication network (e.g. residing in a base station or in the core network) for a terminal having an active connection (e.g. is in RRC CONNECTED state). according to 3GPP is adapted to take communication service quality requirements, e.g. the service class requirements, of the mobile terminal into account, for example in accordance with the above items 1 to 4 and/or the flow described with reference to FIG. 6.

Multi-Band Availability in a Communication System

In case of next generation wireless systems, in particular in the IMT (International Mobile Telecommunications)-Advanced framework, a large number of distant frequency bands are expected to be made available to the operators. The candidate bands for IMT-2000 and IMT-Advanced systems lie between 400 MHz and 5 GHz and in numerical order are:

410-430 MHz

450-470 MHz

470-960 MHz

1 710-2025 MHz and 2 110-2200 MHz

2 300-2 400 MHz

2 500-2 690 MHz

2 700-2 900 MHz

3 400-4 200 MHz

4 400-4 990 MHz.

Some characteristics of these frequency bands vary depending on frequency. For instance, lower frequencies typically allow a better indoor coverage, while higher frequencies typically allow larger bandwidths and thus higher data rates, etc.

According to one embodiment, in case that a plurality of frequency bands are available and one of them is to be selected for allocation to a mobile terminal to a user, such characteristics of the frequency bands are taken into account. According to one embodiment, a mobile terminal is assigned one or more frequency band(s) to provide a communication connection based on the type of application running on the mobile terminal, e.g. based on a type of data traffic (e.g. streaming, burst transmission) carried out by said application.

According to one embodiment, the selection of one or more frequency bands to be allocated to a mobile terminal comprises selecting a contigous frequency spectrum rather than a number of fragmented frequency bands (or vice versa).

For example, a communication service requiring a very high reliability is for example provided using lower frequencies, while a communication service destined for outdoor reception (or with lower Quality of Service requirements) may be provided at higher frequencies. Service initiation may be triggered by the mobile terminal as well as by the mobile communication network (e.g. a base station).

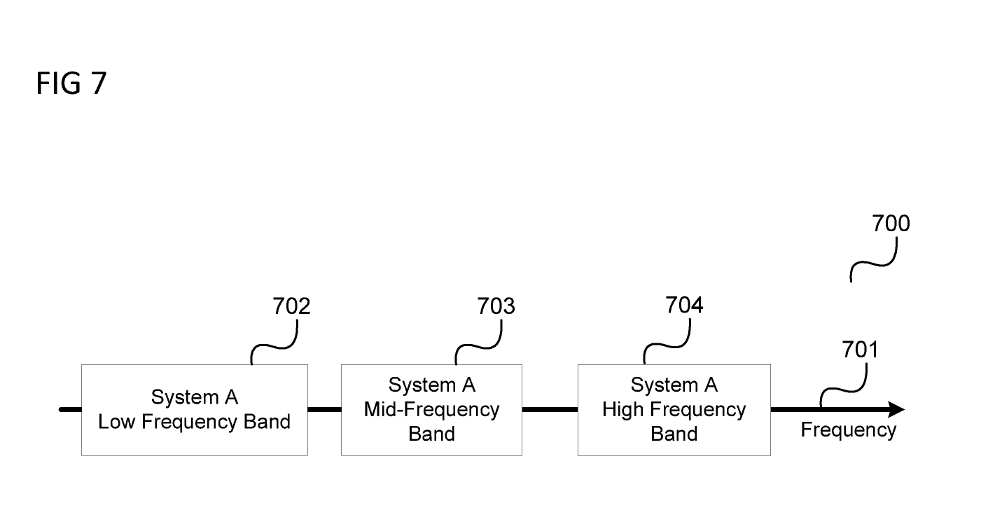

The distribution of frequency regions to mobile terminals depending on Quality of Service requirements according to one embodiment is illustrated in FIG. 7.

FIG. 7 illustrates frequency spectrum allocation according to an embodiment.

In FIG. 7, frequency increases along a frequency axis 701.

In this example, the frequency spectrum, e.g. the available radio frequency spectrum of a mobile communication system, is divided into a low frequency band (or region) 702, a mid-frequency band 703, and a high frequency band 704.

Frequencies of the low frequency band 702 are for example allocated to mobile terminals with high priority and/or high Quality of Service requirements (or for indoor reception).

Frequencies of the medium frequency band 703 are for example allocated to mobile terminals with medium priority and/or medium Quality of Service requirements.

Frequencies of the high frequency band 704 are for example allocated to mobile terminals with low priority and/or low Quality of Service requirements (or for outdoor reception).

For example, email-traffic is not very latency critical and could typically be provided using a high frequency band, possibly in combination with multi-hop techniques in case the cell-sizes are very small (multi-hop concepts allow communication even if the closest base station is very distant; however, the transition via one or multiple intermediate devices typically strongly increases the inherent communication latency).

If multiple frequency bands for operation are available, it is typically always preferable for a mobile terminal to connect to the lowest carrier frequency available providing the requested bandwidth.

However, depending on the type of communication service, a communication service may only be available at a “better” frequency band (i.e. the lower frequency band, e.g. low frequency band 702). Therefore, according to one embodiment, a corresponding management procedure is used.

For example, according to one embodiment, a frequency region of which frequencies are allocated to a mobile terminal is determined in accordance with the following (for example for initial frequency band selection):
1. If the mobile terminal is newly connected to the mobile communication network, the mobile terminal may operate at the highest available frequency.
2. QoS guarantee step: The mobile communication network proposes to the mobile terminal to switch to a lower operating frequency if there are available slots for this frequency (e.g. if there are a sufficient number of available time slots in which the frequency is not allocated etc.; for example, a lower frequency for which there are available slots is identified by the mobile communication network) and if the current operating frequency is not guaranteeing the Quality of Service required and/or requested by the mobile terminal. The mobile terminal can then choose to accept the offer. According to one embodiment, the mobile communication network may, in addition to taking into account the Quality of Service required and/or requested by the mobile terminal, take into account the impact on the interference situation in the mobile communication network when proposing a frequency region to be used by the mobile terminal. For example, the mobile communication network may for interference management only propose frequency regions to be used by mobile terminals such that two neighboring mobile terminals (e.g. mobile terminals located in neighboring cells and/or being closely located to each other) do not use the same frequency region, e.g. the same frequency channel.
3. Distribution of remaining slots: The mobile communication network proposes to the mobile terminal to switch to a lower operating frequency if there are sufficient slots (if not, a lower frequency offering a sufficient number of slots may for example be identified). This proposal may even be made if the current operating frequency is sufficient to guarantee the Quality of Service required and/or requested by the mobile terminal. The mobile terminal can then choose to accept the offer.
4. Re-allocation of slots: If the number of low-frequency slots (i.e. the slots at low frequencies) gets low, the mobile network can choose to move the mobile terminal to a higher frequency (i.e. have the mobile terminal operate at a higher frequency) if this still satisfies the Quality of Service required and/or requested by the mobile terminal

The above steps are for example periodically and/or cyclically repeated.

Contiguous/Non-contiguous Spectrum

For future cellular mobile communication systems, such as according to LTE-A, bandwidth requirements of up to 100 MHz can be expected. Since it is getting difficult to find such large contiguous frequency bands that are not yet reserved, it is planned to aggregate separate parts of frequency spectrum such that a mobile terminal may be provided with an overall bandwidth of, for example, 100 MHz.

Depending on the number of separate parts and the transmission characteristics of the communication systems operating at frequencies in-between these frequency region parts (e.g. whether there a high levels of output power, whether the spectrum mask is sufficiently selective, etc.) the mobile terminal receiver design may be getting complex and the mobile terminal receiver may have high power requirements.

Various levels of aggregated band quality can be expected to exist, i.e. various levels of separation of a frequency band of, e.g. 100 MHz, can be expected to exist which may give rise to different levels of communication service quality.

For example, a mobile terminal may be assigned to a level of a given aggregated band quality depending on the user's subscription type (e.g. whether it is a high revenue user, etc.), its current Quality of Service requirements, etc.

The case of spectrum aggregation is expected to become more and more important in the future, e.g. in the framework of IMT-A which is expected to provide further bands in the 3 GHz, 5 GHz and above range; also, the future availability of White Space communication in the 470-790 MHz range is expected to play a role.

It should be noted that for LTE-Advanced as specified in 3GPP, the terminology ‘carrier aggregation’ is used for the combination of frequency bands used by the same NodeB (base station), while the term ‘Coordinated Multipoint Transmission and Reception (CoMP)’ is used for a scenario in which frequency bands are combined that are used by different NodeBs (base stations) to provide a mobile terminal with a communication service. In both variants the aggregated frequency bands may be either contiguous or non-contiguous. It may be expected that the aggregation of non-contiguous frequency bands requires more sophisticated receivers for the reasons given above.

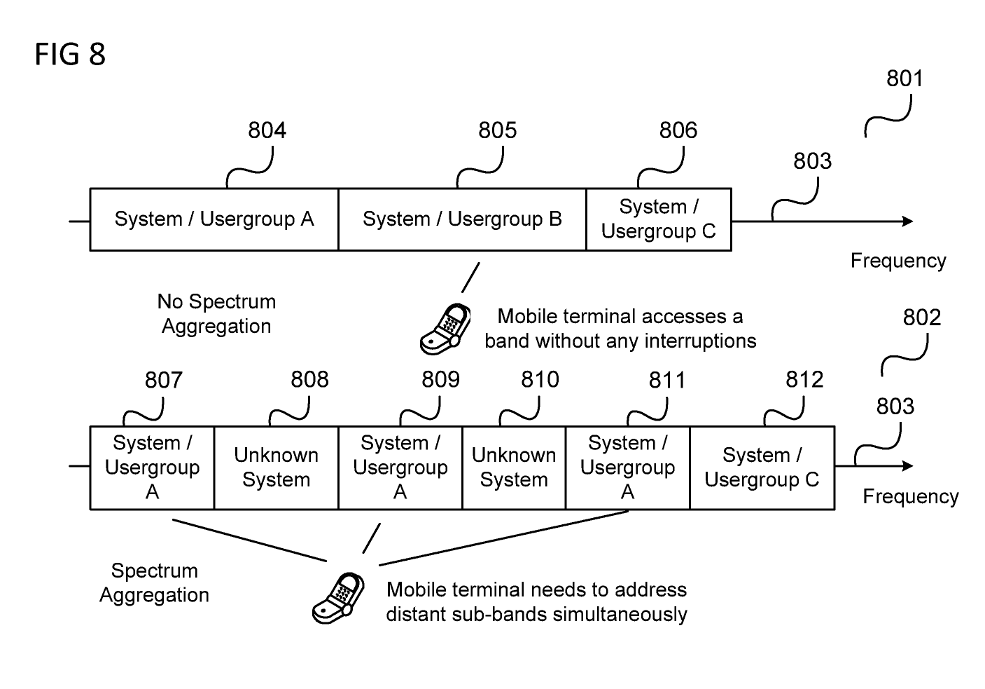

The case of spectrum aggregation is illustrated FIG. 8.

FIG. 8 illustrates frequency spectrum allocation according to an embodiment.

A first diagram 801 illustrates the case of no spectrum aggregation and a second diagram 802 illustrates the case of spectrum aggregation.

In the two diagrams shown in FIG. 8, frequency increases along a frequency axis 803.

In this example, in the case of no spectrum aggregation as illustrated in the first diagram 801, the frequency spectrum is divided into three contigous frequency bands 804, 805, 806 which are for example assigned to different communication systems or different user groups.

In the case of spectrum aggregation as illustrated in the second diagram 802, the spectrum is divided into six parts 807, 808, 809, 810, 811, and 812 (from lower to higher frequencies) wherein a first part 807, a third part 809, and a fifth part 811 form a non-contiguous frequency region (“User Group A”). A second part 808 and a fourth part 810 are in this example allocated to an unknown system (e.g. another mobile communication system or a TV broadcast system etc.) and a sixth part 812 is in this example assigned to a different user group (“User Group C”) than the non-contigous frequency region assigned to “User Group A” made up of the parts 807, 809, and 811.

While in the case illustrated in the first diagram 801a mobile terminal may communicate using a contigous frequency band, a mobile terminal in the case illustrated in the second diagram 802 needs to use separate (e.g. distant) sub-bands simultaneously for communication.

Therefore, if aggregated and non-aggregated frequency bands for operation are available, it is typically desirable for a mobile terminal to use a contiguous frequency band in order to provide the requested bandwidth. However, depending on the type of communication service, a communication service may only be available at a “better suited” frequency band (i.e. a contigous frequency band, e.g. frequency bands 804, 805, 806). Therefore, according to one embodiment, a corresponding management procedure is used.

As mentioned above, the candidate bands for IMT-2000 and IMT-Advanced systems contained in are between 400 MHz and 5 GHz and in numerical order are:

410-430 MHz

450-470 MHz

470-960 MHz

1 710-2025 MHz and 2 110-2200 MHz

2 300-2 400 MHz

2 500-2 690 MHz

2 700-2 900 MHz

3 400-4 200 MHz

4 400-4 990 MHz.

As can be seen, some of these frequency bands are providing only small bandwidths, such that communication resources for a communication service using such bands may need to be distributed over multiple non-contiguous frequency band parts (i.e. the required frequency spectrum needs to be provided by aggregation of a plurality of spectrum parts).

For example, according to one embodiment, a frequency region of which frequencies are allocated to a mobile terminal is determined in accordance with the following:
1. In case the mobile terminal is newly is connected, the mobile terminal may operate at a non-contiguous frequency band if this simplifies i) the frequency band selection and ii) does not disturb other active communication links. Otherwise, a contiguous frequency band is used.
2. QoS guarantee step: The mobile communication network proposes to the mobile terminal to switch to a contiguous frequency band if there is one available for allocation and if the aggregation state of the current frequency band is not sufficient to guarantee the Quality of Service required and/or requested by the mobile terminal The mobile terminal can then choose to accept the offer.
3. Distribution of remaining slots: The mobile communication network proposes to the mobile terminal to switch to a contiguous frequency band if available for allocation. This proposal is for example even made in case the aggregation state of the current frequency band is sufficient to guarantee the Quality of Service required and/or requested by the mobile terminal. The mobile terminal can then choose to accept the offer.
4. Re-allocation of slots: If the number of slots (e.g. the number of available time slots to be allocated, the number of scrambling codes to be allocated, etc.) within contiguous frequency bands gets low, the mobile communication network can choose to move the mobile terminal to a non contiguous frequency band if this still satisfies the Quality of Service requirements of the mobile terminal.

The above steps are for example periodically and/or cyclically repeated.

White Space Usage (Cognitive Radio) by Mobile Terminal as Part of “Secondary System”

Current FCC (Federal Communications Commission) rulings and related IEEE standardization activities (such as IEEE 802.22, IEEE 802.19, etc.) will presumably lead to the availability of spectrum in the 470-790 MHz range for “secondary usage”, i.e. may be used by communication systems for which this spectrum is not a dedicated spectrum (e.g. is not licensed specifically for these communication systems). The spectrum will presumably be attributed to TV broadcasting as the primary user and only if it is not used by this primary user (e.g. in a certain geographical region), a secondary user may access it, e.g. a cellular-like communication system.

In Europe, corresponding discussions are currently held on the regulatory level, in particular the Electronic Communications Committee (ECC) within the European Conference of Postal and Telecommunications Administrations (CEPT) is working towards a European Regulatory Framework for the usage of White Spaces.

While the concerned frequency range may be appealing due to outstanding propagation characteristics, usage of this spectrum as secondary system makes the usage of these frequency bands unreliable and dependent on the current position of the mobile terminals. According to one embodiment, depending on the Quality of Service requirements of a mobile terminal at a given time (e.g. the Quality of Service in function of the communication applications the mobile terminal is currently using), the usage of White Spaces for communication is considered to be or not to be appropriate.

The terms “White Spaces” and “Digital Dividend” refer to the following: Currently, the analogue TV broadcasters stop providing analogue TV and switch to digital TV. Due to the higher spectral efficiency of the digital video technology, the digital TV broadcast techniques occupy less spectrum. Thus, some part of the currently used analogue TV bands can be taken away from the TV broadcasters. Licenses for these frequency bands will presumably be sold in an auction by the regulators, typically to operators of cellular mobile communication systems. This spectrum may then only be used by the future owner—no secondary spectrum access is possible. This is referred to as the “Digital Dividend”.

On the other hand, TV broadcasters will presumably provide digital TV in frequency bands other than the Digital Dividend bands, typically from 470-790 MHz in Europe and between 54-698 MHz in the US (TV channels 2-51; however not all the spectrum between 54-698 MHz is available, there are some parts allocated to other systems, white spaces are only possible to used for those parts that are actually allocated to TV). In these bands, it is expected that secondary spectrum users will be allowed to use this spectrum if it is unused (in a certain geographical area, at a given point in time) by the TV broadcasters. As soon as a TV broadcaster arrives (i.e. the primary system), the secondary system (i.e., e.g., a mobile communciation system) has to switch off immediately. These parts of the spectrum are referred to as “White Spaces”.

In one embodiment, a mobile communication system is used that supports usage of various frequency bands, wherein at least one lies within so-called White Spaces and at least one other frequency band is a dedicated frequency band for the communication system. In case that a user is assigned to operate in the White Spaces, the following advantages and drawbacks need to be considered:
Advantage: The low frequencies of the White Spaces (typically 400-800 MHz) typically leads to very good propagation conditions, large cell sizes, etc. It may in this regard be a preferred spectrum in particular for high mobility users.
Disadvantage: A mobile terminal operating in White Spaces operates as a part of a secondary system in this spectrum and as soon as the primary system starts accessing the frequency band used by the mobile terminal, the mobile terminal must immediately stop using the frequency band. The mobile terminal may then be assigned to another frequency band either within the White Spaces or at a different, but dedicated spectrum of the mobile communication system.

For example, according to one embodiment, a frequency region of which frequencies are allocated to a mobile terminal is determined depending on Quality of Service requirements of user applications running on the mobile terminal and, for example, respective service classes, in accordance with the following:
1. In case the mobile terminal is newly connected, the mobile terminal starts operating in a dedicated band.
2. Assignment to White Spaces: As soon as White Space bands become available, the mobile terminal is proposed to switch to a White Space band depending on the Quality of Service requirements (e.g. a selected service class in accordance with a user application) of the mobile terminal. The mobile terminal may accept to switch to White Spaces or may stay within the dedicated band.
3. Re-assignment to dedicated band/different White Space band: As soon as the primary system starts accessing a White Spaces frequency band assigned to the mobile terminal, the mobile terminal is transferred either to a different White Space frequency band (if available) or to a dedicated frequency band of the mobile communication system.

Heterogenous System Usage

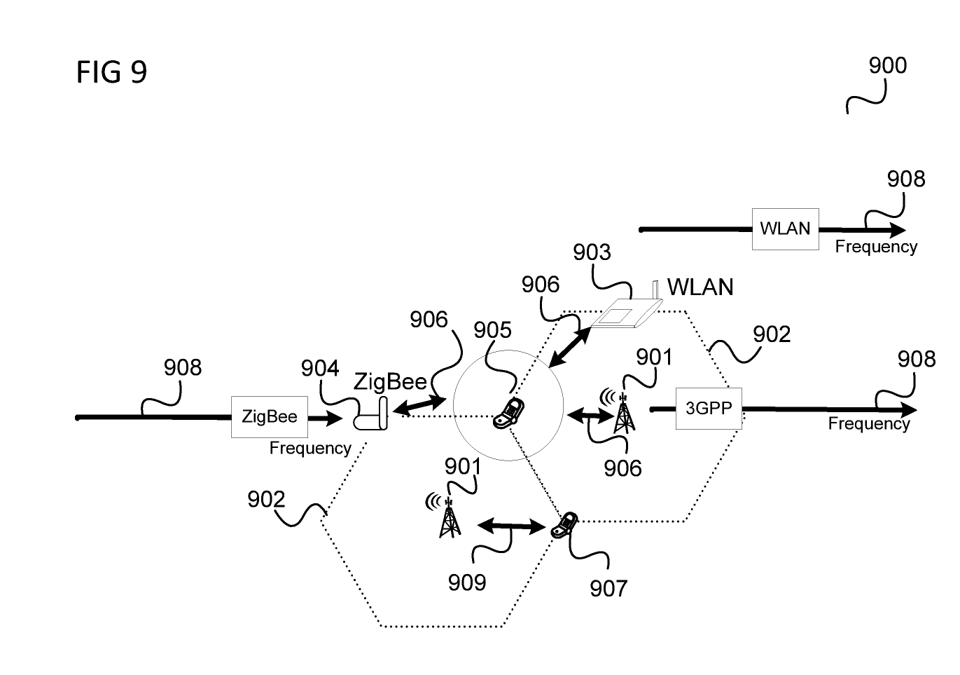

In one embodiment, a communication system is used in which the user has the choice among a plurality of different available wireless systems with overlapping coverage. For example, a heterogenous communication system may be used that includes one or more communication sub-systems according to different radio access technologies such as 3GPP LTE, WiMAX, WiFi, ZigBee, etc. This is illustrated in FIG. 9.

FIG. 9 shows a communication system 900 according to an embodiment.

The communication system 900 includes two eNodeBs 901 operating LTE radio cells 902, a WLAN access point 903, and a ZigBee base station 904. A mobile terminal 905 of the communciation system 900 may have possible communication connections (indicated by arrows 906 to one of the eNodeBs 901, the WLAN access point 903, and the ZigBee base station 904).

Another mobile terminal 907 may for example only have a communication connection to one of the eNodeBs 901 (indicated by arrow 909).

Frequency diagrams 908 illustrate the frequency regions used according to the various radio access technologies, i.e. in this case WLAN, 3GPP LTE, and ZigBee.

For example, each frequency band of the overall spectrum available for the communication system is assigned to a specific radio access technology, or different radio access technologies compete for access in a given frequency band (this is for example already the case for ISM (Industrial, Scientifical and Medical) frequency bands, in the future this can expected to also occur in the White Spaces).

Each communciation sub-system, depending among other parameters on the frequency band it is working in, can offer a certain Quality of Service.

According to one embodiment, a suitable radio access technology according to the Quality of Service requirements of a given mobile terminal is selected.

The different radio access technologies may have different characteristics with respect to coverage area, required output power, robustness to mobility, security, etc. According to one embodiment, depending on the suitability of a radio access technology, the mobile terminal is attributed to one communication sub-system or a plurality communication sub-system simultaneously according to the following rules:
1. In case the mobile terminal is newly connected, the mobile terminal selects the most suitable communication sub-system that offers available slots with respect to the Quality of Service (e.g. the service class) that will be required according to the intended operation of the mobile terminal
2. Assignment to one or more other communication sub-systems if suitable slots (e.g. radio resources to be allocated) become available in the one or more other communication sub-system: If the mobile terminal is not connected to the most suitable sub-system with respect to the Quality of Service requirements and a more suitable sub-system has slots available (that were previously occupied, e.g. another UE leaves), it is proposed to the mobile terminal to transition to the more suitable system.
3. Assignment to another communication sub-system if the radio resources of the current sub-system need to be assigned to other mobile terminals: For example, another mobile terminal A needs access to a fully loaded sub-system that is currently accessed by the mobile terminal B. In this case, mobile terminal B can for example be forced to switch to another (potentially sub-optimum) sub-system in order to free slots for the other mobile terminal A.

It should be noted that the methods for selection of a frequency region to be assigned to a mobile terminal or the selection of a base station to be used by the mobile terminal as described above in case of a system deployment with overlapping radio cells of different types, multi-band availability in a communication system, availability of contiguous/non-contiguous spectrum, the possibility of White Space usage (cognitive radio) by the mobile terminal as “secondary system” and the possibility of heterogenous system usage by a mobile terminal may be (at least partially) combined according to one embodiment, i.e. any combination of the above can be done according to embodiments.

In the examples above the mobile communication network proposes (offers) to the mobile terminal to switch to other (“better suited”) operating frequencies (or frequency bands). In another embodiment the mobile communication network sends out distinct instructions (for instance, a handover command or a reconfiguration command) to the mobile terminal.

Also, in the examples above the mobile terminal may choose to accept the mobile communication network's proposals (offerings). In another embodiment the mobile terminal obeys to the instructions (for instance, a handover command or a reconfiguration command) sent out by the mobile communication network. When the mobile terminal resides in a state where cell selection/reselection takes place, there's not necessarily knowledge of the Quality of Service requirements available when the new connection is established. Therefore, similar methods as used in an embodiment where cell selection/reselection takes place, like described above, can be applied to reconfigurations (such as handovers) during a connection (e.g. a call) and selection of a proper frequency band, sub-system and/or base station during call and/or connection establishment.

For the selection of a suitable frequency region or a suitable base station, one or more of the following criteria may be checked by a component of the mobile communication network or by the mobile terminal:
1. Are there multiple overlapping radio cells of the same radio access technology (e.g., 3GPP LTE with overlapping macro cells, micro cells, pico cells, and/or femto cells, etc.)?
2. Is it possible to select one frequency band out of a plurality of available frequency bands for providing a communication connection (or communication service) to a given user (for example for the same radio access technology, e.g. selection between 1 GHz, 2 GHz, 3 GHz, 4 GHz bands for an IMT-Advanced mobile communication system)?
3. Is it possible to use spectrum aggregation for a given user (i.e., can the mobile communication network split the radio resource allocation over a plurality of non-continuous (potentially distant) frequency bands)?
4. Can a communication connection (or communication service) be provided for the mobile terminal as a secondary spectrum user (e.g. within the TV White Spaces or similar)?
5. Is the mobile terminal able to support communication links to a plurality of sub-systems of a heterogeneous communication system? Is the mobile terminal able to support only one communication link at a time or is the mobile terminal able to use multiple links (e.g. to different sub-systems) simultaneously? In the latter case, communication services can be provided over a plurality of communication sub-systems (not excluding a plurality of communications via different radio access technologies). For example a basic video stream could be provided via a highly robust system while incremental redundancy (allowing for a higher video quality) could be provided by a less robust system. Thus, if the mobile terminal cannot receive the signal over the less robust system, the mobile terminal (and its user) would still be able to obtain the basic video quality.

The mobile terminal, e.g. the mobile terminal 105, 203 of communication system 100, 200 illustrated in FIGS. 1 and 2 may check criterion 1 based on system information of the radio cells. Further, it may check criteria 2 and 3 based on information signalled by the core network 102, 202. Based on its capabilities, it may also check criterion 5.

The mobile communication network, e.g. the core network 102, 202 of communication system 100, 200 illustrated in FIGS. 1 and 2 may check criterion 1 based on measurements (which are accordingly configured). It may also check criteria 2 to 4 based on its own configuration and may check criterion 5 by being provided with information about the mobile terminal's capabilities.

For the user of a mobile terminal, the Quality of Service that may be provided may not be the only criterion for selection of a configuration of a communication connection to be provided, e.g. the frequency region and/or base station to be used. Also, the “expenses” for the user may be of importance for selecting a certain configuration (such as power consumption linked to a given transceiver configuration, service subscription cost, level of security (data encryption), etc.). According to one embodiment, the most suitable configuration is selected based on a metric that takes both into account, the required Quality of Service to be provided as well as the user “expenses”. For example, such a metric may be given as according to Metric M=function ([delivered Quality of Service, User expenses]).

As an example, the following simple metric derivation function may be used:

$$Metric M = {c}_{1} * {f}_{1} ( Minimum Data Rate requirements in \text{Bits/s} [ normalized by the unit \text{“Bits/s”} ] ) + {c}_{2} * {f}_{2} ( Maximum Latency requirement in ms [ normalized by the unit “ ms ” ] ) + {c}_{3} * {c}_{3} ( Maximum allowed Packet Error Rate level in \text{per-cent} [ normalized by the unit “ \% ” ] ) + {c}_{4} * {f}_{4} ( Required UE output Power in Watts [ normalized by the unit “ Watts ” ] ) + {c}_{5} * {f}_{5} ( Required Average Transmission time of UE per packet in ms [ normalized by the unit “ ms ” ] ) + {c}_{6} * {f}_{6} ( Required NB output power in Watts [ normalized by the unit “ Watts ” ] ) + {c}_{7} * {f}_{7} ( user revenues per month [ normalized by the unit “ \$ ” ] )$$

The various functions f₁, f₂, . . . may for example be chosen such that the metric “M” becomes larger with system requirements becoming more challenging, e.g. “f₁(x)=x”, “f₂(x)=x⁻¹”, “f₃(x)=x⁻¹”, “f₄(x)=x⁻¹”, “f₅(x)=x⁻¹”, “f₆(x)=x⁻¹”, “f₇(x)=x”. The example f₇(x) might also be used to choose between a couple of different metrics for premium users or best-effort users. The constants c₁, c₂, c₃, c₄, c₅, c₆, c₇ may for example be typically positive, real valued constants. As simple example, the following selection is possible: c₁=c₂=c₄=c₅=c₆=c₇=1.

In one embodiment, based on the comparison of the metric for a given mobile terminal with, for example, pre-determined thresholds, a communication connection configuration, e.g. a frequency region to be used and/or a base station to be used is selected.

In one embodiment, the selection of the configuration is carried out based on a set of defined service classes. In other words, an indication of the requirements of a mobile terminal (or whishes of the user) as given by the metric M can be expressed by a service class (or a combination of service classes) of one or more sets of service classes, which may for example be communicated from the mobile terminal to the mobile communication network in order to inform the mobile communication network about, for example, the mobile terminal's Quality of Service requirements.

Service classes may for example include application classes that indicate the data rate and latency requirements for an application which is intended to be used by the user of the mobile terminal Examples are given in table 3.

TABLE 3
Application Classes

| Application | |
|---|---|
| Class | Explanation |
| AC₁ | Voice traffic |
| AC₂ | Data traffic, low-data rate, no real-time data |
| | (“best-effort” Internet surfing) |
| AC₃ | Data traffic, low-data rate, real-time, but uncritical initial |
| | latency (e.g., streaming audio) |
| AC₄ | Data traffic, low-data rate, real-time and low-latency |
| | (e.g., gaming) |
| AC₅ | Data traffic, high-data rate, no real-time data |
| | (e.g., email, file down/up-load) |
| AC₆ | Data traffic, high-data rate, real-time data |
| | (e.g., streaming high-resolution video) |

Further, service classes may for example include mobility classes that indicate a user mobility profile. Examples are given in table 4.

TABLE 1
Mobility Classes

| Mobility Class | Explanation |
|---|---|
| MC₁ | Static User (no mobility) |
| MC₂ | Pedestrian User (low mobility) |
| MC₃ | Medium-Speed User (e.g., car driving within a city, |
| | at 50 km/h metro line, etc.) |
| MC₄ | High-Speed User (e.g., car driving on German |
| | Autobahn at 250 km/h) |
| MC₅ | Ultra-High-Speed User (e.g., next generation train |
| | running at 650 km/h) |

Additional types of service classes may be used in addition to the above.

In one embodiment, a combination of the usage of a metric and service classes is used. For example, in case that it has to be decided to which of two mobile terminals a certain frequency region is to be allocated (e.g. a low frequency region having desirable properties) and the two mobile terminals have the same service class, the above metric may be evaluated for deciding to which of the two mobile terminals the frequency region is allocated (e.g. to the mobile terminal for which the metric has the higher value).

Service initiation can be triggered by a mobile terminal or by a base station. According to one embodiment, depending on the awareness of the criteria described above the appropriate configuration (i.e. the frequency region to be used and/or the base station providing the communciation connection) can be selected by a component of either the core network or of the mobile terminal.

For example, in one embodiment, the Serving Gateway 205 of the communication system 200 shown in FIG. 2 includes an analysis entity (e.g. an analysis circuit) 220 and the MME 208 includes a configuration controller 221 (e.g. a configuration circuit 221).

The analysis entity 220 for example analyzes all u-plane (user plane) data (i.e. analyzes user data, e.g. user data streams, transmitted and/or received by the mobile terminal 230) and derives Quality of Service requirements from the data and informs the configuration controller 221 about the Quality of Service requirements and/or of changes of the Quality of Service requirements. In one embodiment, the analysis entity 220 may predict changes of the Quality of Service requirements that are likely to occur. Based on the Quality of Service requirements, the configuration controller 221 selects a configuration of the communication connection provided for the mobile terminal 203, e.g. a frequency region to be assigned to the mobile terminal 203. For example, the configuration controller 221 operates as a carrier aggregation controller and determines whether to allocate a non-contiguous frequency region or a contiguous frequency region to the mobile terminal 203. The configuration controller 221 may also, based on the Quality of Service requirements, determine a base station which is to serve the mobile terminal 203 and may for example instruct the mobile terminal 203 to attach to this base station.

The selection process carried out by the configuration controller 221 may also include addition and/or removal of frequency bands, component carriers, extension carriers, and/or carrier segments to/from the frequency region assigned to the mobile terminal 203. Also, the selection process may also include selection of frequency bands of different radio access technologies and the radio access technology to be used by the mobile terminal 203.

In one embodiment, in a dynamic scenario in which the type of data traffic (and thus the Quality of Service requirements) changes over time, the selection process may be carried out dynamically, i.e. triggered by a change of the type of data to be transmitted.

A configuration may for example be selected and assigned to the mobile terminal 203 based on the following:
a. Identify all configurations which satisfy the Quality of Service requirements of the mobile terminal (e.g. in alignment with Service Classes as described above),
b. Classify the identified configurations by required user expenses, define metric values correspondingly,
c. Attribute a configuration following the classification results in b.

The selection process may be carried out by the mobile terminal 203 or by the mobile communication network. For instance, the configuration selection in the cases of system deployment with overlapping radio cells of different types, multi-band availability in a communication system, availability of contiguous/non-contiguous spectrum, and the possibility of White Space usage (cognitive radio) by the mobile terminal as “secondary system”, the corresponding configuration selection, as described above, may be carried out on the mobile communciation network side, e.g. by a network component such as the MME 208 as described above.

In the case of the possibility of heterogenous system usage by the mobile terminal, the selection of the configuration (i.e. of the radio access technology to be used) is in one embodiment carried out by the mobile terminal itself which may have complete knowledge of all deployed communication (sub-)systems in its vicinity.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for configuration of a mobile communication system comprising a mobile communication network and a mobile terminal, the method comprising:
determining a communication service quality required by a software application running on the mobile terminal for the transmission of data to be transmitted via a communication connection between the mobile communication network and the mobile terminal; and
determining at least one of
a base station of the mobile communication network to provide the communication connection and
a radio frequency region to be used to provide the communication connection
based on the required communication service quality.

2. Method according to claim 1, wherein the mobile communication network is a wide area network.

3. Method according to claim 1, wherein the base station is a base station of a plurality of base stations operating radio cells of a wide area network cell type.

4. Method according to claim 1, wherein at least one of the base station and the radio frequency region is determined based on a predetermined selection criterion.

5. Method according to claim 1, wherein the communication service quality is a Quality of Service required by the software application.

6. Method according to claim 1, wherein the determination of a base station of the mobile communication network comprises the selection of a base station of a plurality of base stations.

7. Method according to claim 6, wherein at least two base stations of the plurality of base stations are base stations according to different radio access technologies.

8. Method according to claim 6, wherein at least one base station of the plurality of base stations is a macro base station and at least one base station of the plurality of base station is a low power node.

9. Method according to claim 1, wherein the low power node operates a micro cell, a femto cell or a pico cell.

10. Method according to claim 1, wherein the determination of a base station of the mobile communication network comprises the selection of a plurality of base stations to provide the communication connection.

11. Method according to claim 1, wherein the determination of a radio frequency region to be used to provide the communication connection comprises selecting a frequency region from a plurality of frequency regions.

12. Method according to claim 11, wherein at least one frequency region of the plurality of frequency regions is contiguous and at least one frequency region of the plurality of frequency regions is non-contiguous.

13. Method according to claim 11, wherein the plurality of frequency regions comprises a first frequency region and a second frequency region and the frequencies of the first frequency region are higher than the frequencies of the second frequency region.

14. Method according to claim 11, wherein the plurality of frequency regions comprises at least one frequency region assigned to another mobile communication system.

15. Method according to claim 11, wherein the plurality of frequency regions comprises at least one White Space frequency region.

16. Method according to claim 11, wherein the plurality of frequency regions comprises at least one dedicated frequency region of the mobile communication system.

17. Method according to claim 1, the determining of the communication service quality required by the software application comprising analyzing a type of data transmitted between the mobile communication network and the mobile terminal.

18. Method according to claim 1, the determining of the communication service quality required by the software application comprising determining a communication service used by the software application.

19. Method according to claim 1, the determining of the communication service quality required by the software application comprising receiving, by the mobile communication network, an indication of the communication service quality from the mobile terminal.

20. Method according to claim 1, further comprising providing a communication connection for the mobile terminal according to the determination of a base station and/or a radio frequency region.

21. Method according to claim 1, being at least partially carried out by a component of the mobile communication network.

22. Method according to claim 1, being at least partially carried out by the mobile terminal.

23. Method according to claim 1, further comprising
checking whether another base station other than the determined base station is available for providing another communication connection between the mobile communication network and the mobile terminal ensuring the communication service quality; and
providing the other communication connection for the transmission of the data using the other base station if the other base station is available for providing the other communication connection and if a predetermined criterion is fulfilled.

24. Method according to claim 23, wherein the predetermined criterion is that the other communication connection ensures a higher communication service quality than the communication connection or that the determined base station will no longer be available for providing the communication connection.

25. Method according to claim 1, further comprising
checking whether another radio frequency region other than the determined radio frequency region is available for providing another communication connection between the mobile communication network and the mobile terminal allowing a higher communication service quality than the determined radio frequency region; and
providing the other communication connection for the transmission of the data using the other frequency region if the other frequency region is available for providing the other communication connection and if a predetermined criterion is fulfilled.

26. Method according to claim 25, wherein the predetermined criterion is that the other communication connection ensures a higher communication service quality than the communication connection or that the determined base station will no longer be available for providing the communication connection.

27. A device for configuration of a mobile communication system comprising a mobile communication network and a mobile terminal, the device comprising:
a first determining circuit configured to determine a communication service quality required by a software application running on the mobile terminal for the transmission of data to be transmitted via a communication connection between the mobile communication network and the mobile terminal; and
a second determining circuit configured to determine at least one of
a base station of the mobile communication network to provide the communication connection and
a radio frequency region to be used to provide the communication connection
based on the required communication service quality.
